(19) United States
(12) Patent Application Publication
(10) Pub. No.: US 2013/0261278 A1
(43) Pub. Date: Oct. 3, 2013

(54) Polyethylene production improvement

(71) Applicant: John G. Nelson, Pauls Valley, OK (US)

(72) Inventor: John G. Nelson, Pauls Valley, OK (US)

(73) Assignee: John G. Nelson, Pauls Valley, OK (US)

(21) Appl. No.: 13/374,688

(22) Filed: Apr. 2, 2012

(51) Int. Cl. C08F 110/02

(52) U.S. Cl. 526/352

(57) ABSTRACT

Liquid ethylene is used to cool the hot froth in the high pressure separator. This prevents the thermal degradation that occurs during the transition from the reactor to pelletizing. Low density polyethylene with superior physical properties is the result.

Low density polyethylene is produced from ethylene under very high pressure. The process is exothermic; the conversion of ethylene to polyethylene is limited by the high temperature of the reaction mixture.

High pressure ethylene exhibits a reverse Joule-Thompson effect as it expands. The hot polyethylene is heated higher by the expanding ethylene gas. Removing the hot ethylene from the polyethylene results in a time delay before the polyethylene is cooled. During this time period thermal fracturing of the polyethylene occurs. Some of the best properties of the polyethylene are lost.

This invention adds liquid ethylene to the hot froth as it exits the reactor to the high pressure separator. The hot polyethylene is cooled, and a higher quality product is produced.

For example: there is approximately a twenty-five minute transit time for the poly ethylene from the time it leaves the reactor to the time it is cooled by the pelletizing water. If, during the production of a 2 melt index polyethylene, the transit of the polyethylene is delayed for an extra hour, the melt index deteriorates to several hundred. This invention stops the deterioration that occurs during the normal transit time. A higher quality polyethylene is the result.

The average reactor has five to ten downtimes per year of at least two hours. During this downtime the twenty-five minutes of production between the reactor and the water pelletizer are cooked to scrap. This invention saves 125 minutes to 250 minutes of premium polyethylene each year per reactor.

Very pure ethylene [99.94% plus] is used as feedstock. During production, fragments from the thermally cracking polyethylene contaminate the unreacted ethylene so that it cannot be recycled as feedstock. This invention preserves the high purity of the ethylene so that it can be recycled to extinction. This results in a production cost savings of over ten percent.

The desirable properties of polyethylene: haze, gloss, impact resistance, tensile strength, permeability etc. are adversely affected by the thermal cracking. Preservation of these properties by cooling with ethylene allows the production of products that can command a premium price.

1. This invention allows the production of superior quality polyethylene that can command a superior price.

2. This invention saves 125 minutes to 250 minutes of premium polyethylene production each year per reactor.

3. This invention preserves the high purity of the unreacted ethylene so that it can be recycled to extinction. This results in a production cost savings of over ten percent.
